(19) United States
(12) Patent Application Publication
(10) Pub. No.: US 2013/0119679 A1
(43) Pub. Date: May 16, 2013

(54) EMERGENCY DOOR LOCKING DEVICE FOR HOUSEHOLD APPLIANCES

(71) Applicant: Elettrotecnica Rold S.R.L. (Italian Limited Liability Company), Nerviano (IT)

(72) Inventor: Stefano Rocchitelli, Pogliano Milanese (IT)

(73) Assignee: Elettrotecnica Rold S.R.L. (Italian Limited Liability Company), Nerviano (IT)

(21) Appl. No.: 13/679,192

(22) Filed: Nov. 16, 2012

(30) Foreign Application Priority Data
Nov. 16, 2011 (IT) MI2011A002081

(51) Int. Cl. E05C 1/00; E05B 47/00; E05C 1/08

(52) U.S. Cl. CPC E05C 1/004; E05C 1/08; E05B 47/00
USPC 292/164

(57) ABSTRACT

The present invention relates to an emergency door locking device for household appliances, in particular for tumble dryers,

More specifically, the device according to the present invention allows the door of a household appliance to be locked, thus preventing the opening thereof by the user, when a predetermined temperature, deemed anomalous and/or dangerous, is reached inside the compartment of the household appliance.

The emergency device according to the present invention therefore constitutes a mechanical safety, which is therefore also able to operate when the anomalous event that caused the increase in temperature compromises the correct operation of the control electronics of the household appliance.

This application claims the benefit of Italian Patent Application No. MI2011A002081 filed Nov. 16, 2011, which is hereby incorporated by reference in its entirety.

### FIELD OF THE INVENTION

The present invention relates to an emergency door locking device for household appliances, in particular for tumble dryers.

More specifically, the device according to the present invention relates to a device suitable for locking the door of the household appliance, thus preventing the opening thereof by the user, when a predetermined temperature is reached inside the household appliance compartment.

### BACKGROUND OF THE INVENTION

Door locking devices suitable for preventing the accidental or voluntary opening of the door of the household appliance by the user under certain conditions are currently available on the market and commonly used in the sector of household appliances such as washing machines, tumble dryers, ovens and so forth.

For example, the use of said door locking devices in household ovens is known in the prior art, in particular in self-cleaning ovens with pyrolysis function, but also in washing machines, in which the door locking device is controlled by the control electronics of the household appliance and keeps the door tightly closed during the entire operating cycle of the household appliance.

In certain types of household appliances however, a further safety function may be required that is not linked to the normal operating cycle of the household appliance itself but is linked to the occurrence of specific emergency situations.

One example of such a situation may be the case in which a fire starts, or in any case, a higher than normal temperature is recorded inside the drum of a washing machine. In this situation, which could also compromise the correct operation of the control electronics of the household appliance itself, there is currently a need which is not met, for an additional mechanical safety device to prevent the door from being opened.

Indeed, as is known by those with planning experience, purely mechanical safety devices capable of guaranteeing operation, even when the device's control electronics have been compromised, are generally envisaged alongside electronic devices.

### SUMMARY OF THE INVENTION

The main aim of the present invention is therefore that of providing an emergency door locking device, suitable for firmly locking the opening of the door only on the occurrence of certain, predetermined conditions, which constitutes a mechanical safety lock, thus allowing a need identified in the sector to be met.

In particular, the aim of the present invention is that of providing a thermostatic emergency door locking device that is suitable for entering into operation only on the reaching of a predetermined temperature. Even more in particular, said device, once placed in the compartment of the household appliance at the level of the door's hook closure, detects the temperature present inside the internal compartment of the household appliance and releases, thus locking the door once said temperature reaches a threshold value.

Within the scope of these aims, the object of the present invention is to provide a mechanically activated, emergency door locking device suitable for being released thus locking the door within a predetermined time interval from when the temperature inside the household appliance has reached a predetermined threshold value.

Yet another object of the present invention is that of providing a door locking device suitable for use with doors having hook closures of different dimensions.

Not last, object of the present invention is that of providing a door locking device capable of eliminating the dimensional tolerances that are to be found on the hook closures of the doors of domestic appliances.

This aim and these and other objects that will become clearer below following a detailed description of the present invention given here by way of a non-limiting example, are achieved by a safety door locking device comprising a main body to which sliding locking means of the door hook of the household appliance are associated, said locking means being mobile between a first inactive position in which said means do not interact with said door hood and a second, locking position of the door in which said means interact with said door hook, said locking means being associated to an elastic element adapted to move said locking means from said first position that is retracted towards the external of said main body in said second locking position, characterised in that the said locking means comprise, at the end intended to come into contact with said hook of said door, a serrated profile, said profile further presenting at least one abutment adapted to be held by a portion of a thermostatic element, so as to keep said locking means in a retracted position when the temperature detected by said thermostatic element is lower that a predetermined value T₁.

### BRIEF DESCRIPTION OF THE DRAWINGS

Further characteristics and advantages of the present invention shall become clearer from the following detailed description, provided by way of a non-limiting example and is illustrated in the annexed drawings, wherein:

FIG. 1 shows a perspective top view of the door locking device according to the present invention in accordance with a first embodiment thereof;

FIG. 2 again shows a perspective top view of the device of FIG. 1 in a condition wherein the locking means do not interact with the door hook;

FIG. 3 shows a sectional side view of the door locking device in accordance with the embodiment of drawings 1 and 2, in a condition in which the said locking means interact with the door hook;

FIG. 4 shows a detail of the thermostatic element according to the first embodiment of the device of the present invention;

FIG. 5 shows a perspective top view of the door locking device according to the present invention in accordance with a second embodiment thereof;

FIG. 6 again shows a perspective top view of the device of FIG. 5 in a condition in which the locking means do not interact with the door hook;

FIG. 7 shows a sectional side view of the door locking device in accordance with the embodiment of drawings 5 and 6, in a condition in which the said locking means interact with the door hook;

FIG. 8 shows a detail of the thermostatic element according to the second embodiment of the device of the present invention;

FIG. 9 shows the device according to the present invention, coupled with the door hook of a household appliance. The figure shows how the device is able to eliminate any misalignment of the hook and the device.

### DETAILED DESCRIPTION OF THE INVENTION

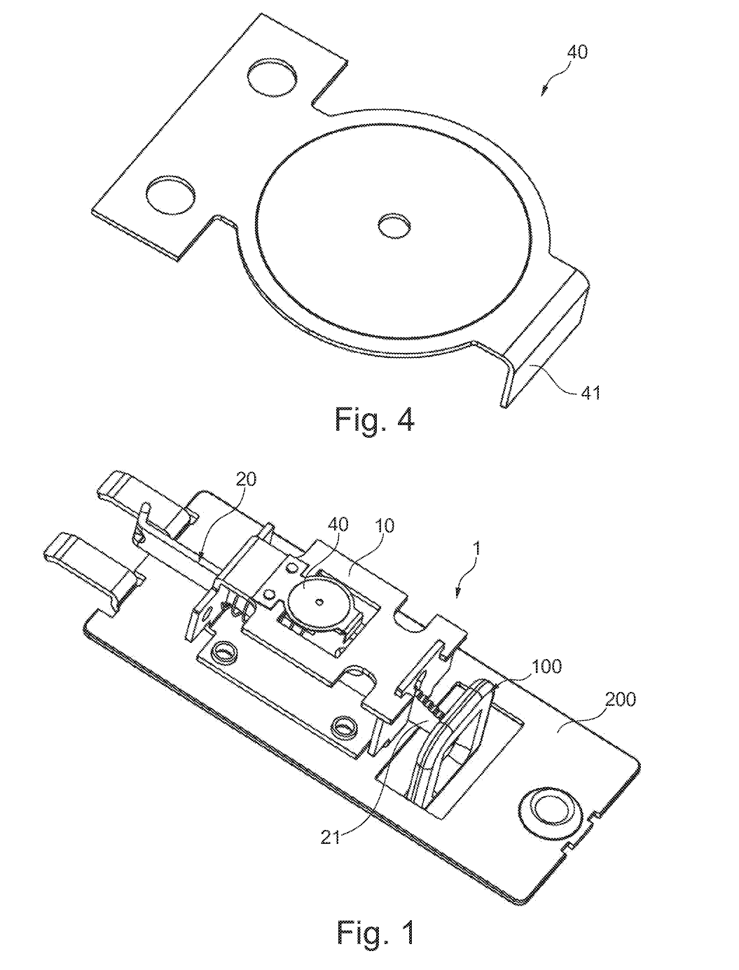

With particular reference to FIG. 1, the device 1 according to the present invention comprises a main body 10 preferably having a box shape.

The main body 10 can be advantageously made of a single, suitably bent sheet element, or can be obtained the unison of multiple sheet metal parts, but could also be obtained from other materials having physical and mechanical properties suitable for the purpose.

The main body 10 is intended to be firmly connected to the household appliance or to a part thereof 200 inside the compartment of the household appliance itself and in proximity of the door, in particular of the door's hook closure 100.

The device according to the present invention comprises locking means 20 of said door that are movable between a first position in which said means do not interact with said door hook 100 and a second locking position of the door in which said means interact with said door hook 100.

Said locking means comprise, in the example shown in the accompanying drawings, a rod 20 having a substantially longitudinal development, which presents at least one portion 21 shaped like a blade adapted to interact with said hook 100 of said door of the household appliance when said locking means are in the second locking position.

In particular, at the level of said first position in which said means do not interact with said hook 100, said rod 20 is refracted within the main body 10 of the device, while at the level of the second door locking position, said road protrudes from the main body 10 of the device towards the outside from the part of said main body which, when the device is assembled onto the household appliance as shown in FIG. 1, faces towards said hook 100, the end portion 21 of said road going on to interact with said hook 100 thus maintaining the door in a closed position.

According to the preferred embodiment shown in the accompanying drawings, the rod 20 has a substantially longitudinal development, and is shaped like a foil, the thickness of which is contained.

Other forms may naturally be envisaged by persons skilled in the art according to their specific experience and without deviating from the scope of protection of the present invention defined by the accompanying claims.

As mentioned, the rod 20 presents one end 21 adapted to interact with the hook 100 of said door. In particular, the end 21 of said rod presents, on a longitudinal plane, an inclined profile, that is for example triangular or wedge-shaped.

With particular reference to the view of FIG. 3, which shows a section of the present device with an axial longitudinal plane, it is noted how the rod 20 presents at the level of the end 21 a tapered section in the advancement direction of the rod 20 from the first inactive position to the second door locking position. Said tapered section further presents a serrated profile 23.

Defining the terms “above”, “below”, “lower” and “upper”, in compliance with the identified direction of the axis Z of the reference system shown in FIGS. 1 and 3, and the terms “front” and “rear”, “advancement” e “backward motion” with reference to the identified direction of the axis X, said end 21 of the rod 20 is wedge-tapered and presents, at least at the level of its upper edge, a serrated profile comprising a plurality of serrations 23, each of said serrations being suitable to abut the internal profile of said hook 100, which is normally ring-shaped.

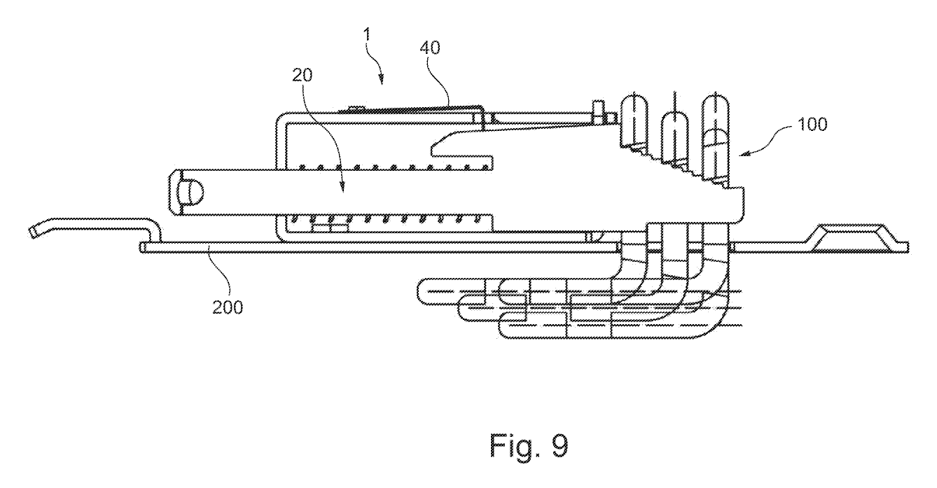

Thanks to the particular wedge-shape of the end 21 of the rod 20, and thanks in particular to the serrated profile comprising a plurality of 23 at least on the upper edge of said end 21, the rod 20 is able to insert itself inside the ring of the hook 100, thus eliminating any slack or tolerances that may exist between the positioning of the hook 100 and that of the device 1. Said advantage obtainable by the device according to the present invention is well illustrated by FIG. 9, in which it is noted how the plurality of serrations 23 of the serrated profile and the wedge-shape of the end 21 of the rod 20 are able to eliminated misalignments of the door hook 100 in respect of both the axis X and the axis Z.

Indeed, in particular, it is intuitive how the end 21 of the rod 20 will always be able to find the desired interference with the internal profile of the hook 100, even when the positioning of the ring of the hook along the axis Z should not be perfectly aligned in respect of the rod 20.

The function carried out by the presence of the serrated profile of the end 21 will become clearer once the methods by which the rod 20 moves along the direction X have been illustrated.

The movement of said rod 20 along the longitudinal direction X takes place thank to the presence of actuating means 30.

In particular, in the example shown in the drawings, said actuating means 30 comprise elastic means, in particular a helical spring 30, interposed between said main body 10 and said rod 20.

In particular, said helical spring 30 is compressed when said rod 20 is in said first position, refracted inside said main body 10, in which it does not interfere with said hook 100 of said door. In this condition therefore the action of the spring exercises a force on said rod 20, onto which the spring itself abuts, which tends to push the rod 20 into said second locking position of the door hook, in which the end 21 of said rod 20 protrudes from the main body 10.

The device according to the present invention thus further comprises at least one thermostatic element 40 comprising at least one abutment adapted to interact with said locking means 20 thus contracting the thrust exercised on said locking means 20 by the spring 30 when said locking means are in the first position of non interference with said hook 100 of said door.

In the examples shown in the accompanying drawings said thermostatic element 40 is made of a bimetal.

As is known in the prior art, the term “bimetal” here indicates a sheet consisting of two thin metal bands, each having different chemical and physical properties, that are joined together by means of any procedure whatsoever, for example by means of lamination or compression.

In the present patent description, the term “bimetal” indicates a thermal bimetal or bimetallic foil, with which the springs, discs, foils for sensitive elements of thermostats, switches and similar are made, according to what is known in prior art. It is thus formed by two metals having very different linear expansion coefficients from each other (for example iron and brass, nickel and iron, platinum and iridium). The bimetal flexes by effect of the temperature variation.

Bimetal deformation can be controlled by suitably selecting the materials, the thicknesses and so forth, so as to “programme” the bimetal to deform at a given temperature T₁.

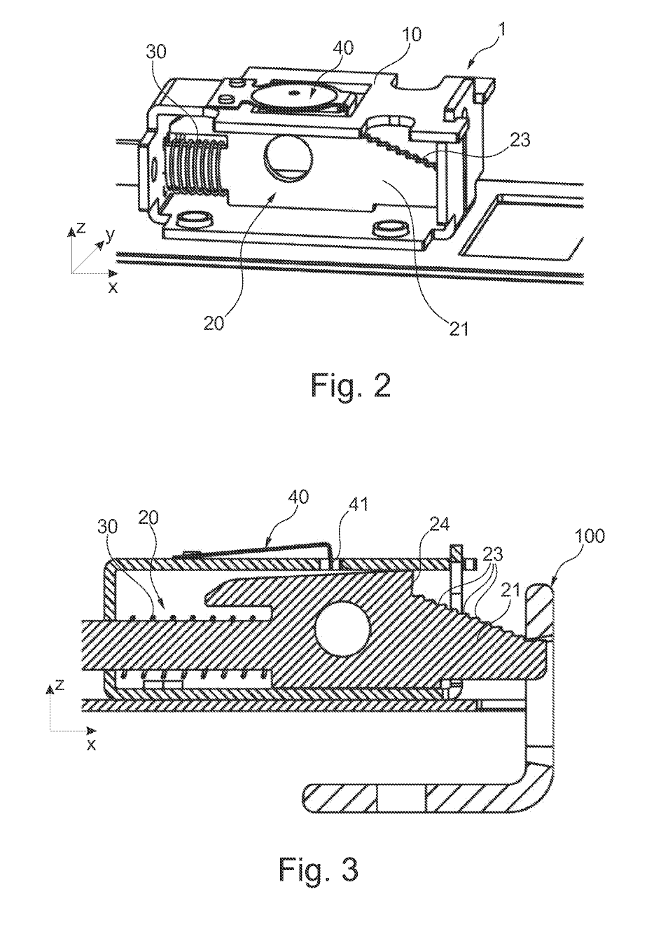

According to the first embodiment of the device according to the present invention, shown in FIGS. 1 to 4, the thermostatic element 40 is made of a bimetal with non-linear deformation, preferably of the “on-off” type also indicated in the sector by the English term “snap”, adapted to firmly maintain said locking means 20 in their first position when the temperature detected by said thermostatic device is inferior to a predetermined value T₁. Since, as mentioned, the device according to the present invention is advantageously positioned inside the compartment of the household appliance, it detects the temperature T present inside the compartment.

When the temperature T inside the compartment exceeds the predetermined threshold value T₁, the bimetal 40 instantly deforms, the portion 41 of said bimetal 40 no longer abuts the portion 24 of said locking means 20, and the rod 20 is therefore free to move forward towards the locking position of the door pushed by the spring 30.

According to the first preferred embodiment of the present invention shown in FIGS. 1 to 4, the thermostatic element 40 is made of a bimetal with non-linear deformation.

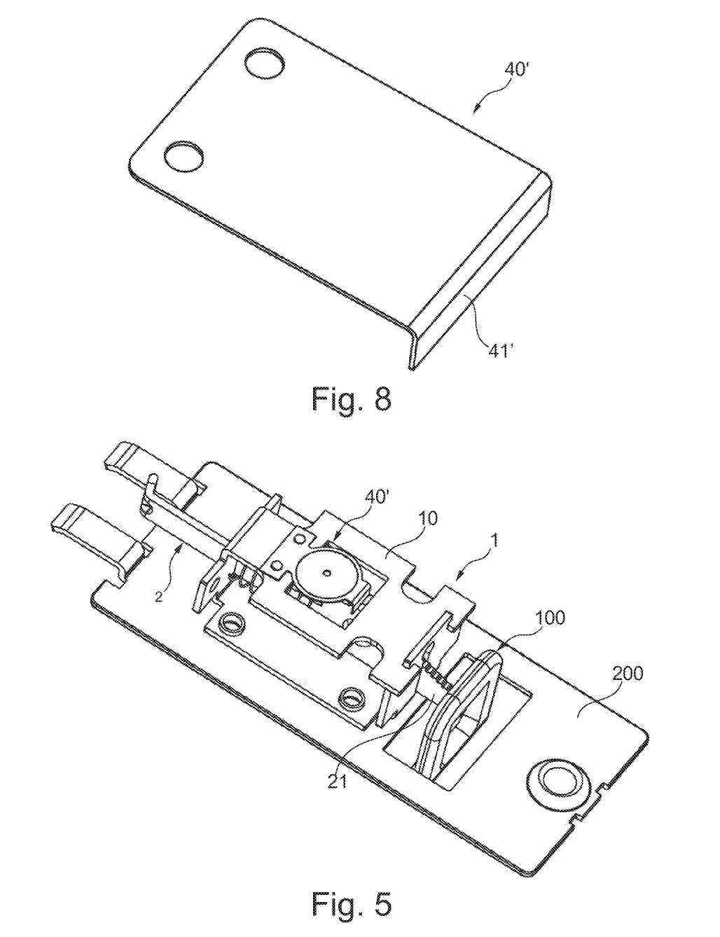

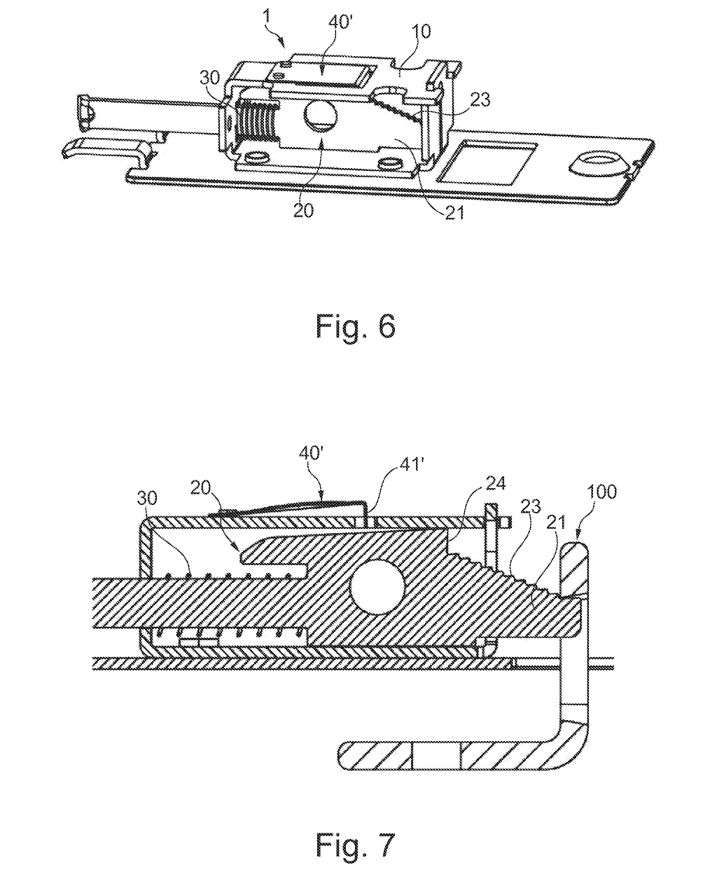

When the device 1 according to the present invention is equipped, as in the second embodiment of FIGS. 5 to 8, with a bimetal with linear deformation, when the temperature detected by the device reaches the value T₁ the linear deformation of the bimetal element 40′ begins to deform and the safety device 1 does not therefore immediately snap into closing the door, but there will be a transitional period from the moment in which the device detects the temperature T₁ and the moment in which the serration 41′ frees the rod 20, triggering the device.

By suitably dimensioning the thicknesses of the bimetal and suitably selecting the type of materials that comprise it, it is possible to determine the duration of the deformation transition of the bimetal 40′.

It has thus been shown that the method and the apparatus according to the present invention achieve the proposed aim and objectives.

In particular, it has been illustrated how the door locking device according to the present invention allows a single, extremely simple mechanical safety device to be used that is suitable for producing the locking of the door of a household appliance on a predetermined temperature being reached.

It has also been shown how the emergency door locking device according to the present invention allows any alignment problems between the locking device itself and the door hook, thus simplifying the assembly operations of the device, particularly as regards the dimensional control of the positioning.

A number of changes can be made by the sector profession without straying from the scope of protection pursuant to this invention.

The scope of protection of the claims should not therefore be restricted to the illustrations or to the preferred embodiments provided by way of example in the description; the claims should instead include all the characteristics of patentable novelty arsing from the present invention, including all the characteristics that are deemed to be equivalent by a person skilled in the art.

What is claimed:

1. An emergency door locking device (1) for locking the door of a household appliance in closed position, of the type comprising a main body (10), locking means for locking said door adapted to interfere with the hook (100) of said door, and at least one thermostatic element (40, 40′), wherein said locking means (20) are movable with respect to said main body (10) between a first inactive position in which they do not interact with said door hook (100) and a second active locking position of the door in which at least one portion (21) of said means (20) interacts with said door hook (100) by holding it in closed position, and in that said locking means (20) have, at said at least one portion (21) intended to interfere with said hook (100), a section tapered in the advancement direction of said locking means (20) from the inactive position towards the active position, said tapered section having a serrated profile (23).

2. A door locking device (1) according to claim 1, wherein the serrated profile (23) of said tapered section of said locking means (20) is obtained at the upper edge of said portion (21).

3. A door locking device (1) according to claim 2, wherein said portion (21) adapted to interact with said hook (100) is the end portion of a rod-like element (20) shaped like a blade.

4. A door locking device (1) according to claim 1, wherein it comprises further actuating means (30) of said locking means (20), said actuating means being of elastic type.

5. A door locking device (1) according to claim 4, wherein said actuating means comprise a helical spring (30) interposed between said main body (10) and said rod-like element (20).

6. A door locking device (1) according to claim 5, wherein said helical spring (30) is compressed when said locking means (20) are in said first inactive position.

7. A door locking device (1) according to claim 6, wherein said locking means (20) are held in said first inactive position by said thermostatic element (40, 40′) until said thermostatic element changes its shape following the reaching of a predetermined temperature (T₁).

8. A door locking device (1) according to claim 1, wherein said thermostatic element is made of a nonlinear behaving bimetal (40).

9. A door locking device (1) according to claim 1, wherein said thermostatic element is made of a linear behaving bimetal (40′).

10. A household appliance comprising the door locking device (1) according to claim 1.
